(19) United States
(12) Patent Application Publication
(10) Pub. No.: US 2025/0178461 A1
(43) Pub. Date: Jun. 5, 2025

(54) ELECTRIFIED VEHICLES, BATTERY SYSTEM ARCHITECTURES, AND CONTROL LOGIC FOR VEHICLE-TO-VEHICLE CHARGING

(71) Applicant: GM GLOBAL TECHNOLOGY OPERATIONS LLC, Detroit, MI (US)

(72) Inventors: Rashmi Prasad, Troy, MI (US); Chandra S. Namuduri, Troy, MI (US); Ananth Padmanabha Rao Vemuri, White Lake, MI (US); Ramadityanand Bhogadi, Rochester Hills, MI (US); Brandon R. Jones, White Lake Twp., MI (US)

(73) Assignee: GM GLOBAL TECHNOLOGY OPERATIONS LLC, Detroit, MI (US)

(21) Appl. No.: 18/529,362

(22) Filed: Dec. 5, 2023

(51) Int. Cl. B60L 53/14; B60L 58/12; H02J 7/00

(52) U.S. Cl. CPC B60L 53/14; B60L 58/12; H02J 7/0013; H02J 7/00712; B60L 2210/10; B60L 2240/547

(57) ABSTRACT

Presented are high-voltage (HV) electrical system architectures for vehicle-to-vehicle (V2V) charging of vehicle batteries, methods for making/using such systems, and vehicles equipped with such systems. An HV electrical system for a motor vehicle includes a main HV bus that electrically connects the vehicle's traction motor(s) to the vehicle's battery pack(s), and a charging inlet port that electrically mates with and receives direct-current (DC) power from DC fast-charging (DCFC) cables of a donor vehicle and a charging station. A DC-to-DC (DC-DC) converter is interposed between and electrically connects the charging inlet port to the main HV bus. The DC-DC converter is operable in a bypass mode, in which the DC-DC converter passes therethrough DC power received from the DCFC cable of the charging station, and a vehicle-to-vehicle (V2V) mode, in which the DC-DC converter modulates DC power received from the DCFC cable of the donor vehicle.

### INTRODUCTION

The present disclosure relates generally to rechargeable electrochemical devices. More specifically, aspects of this disclosure relate to high-voltage electrical systems for vehicle-to-vehicle (V2V) charging of traction batteries of electrified vehicles.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability, power output capacity, relative light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, rechargeable battery cells, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

### SUMMARY

High-voltage (HV) electrical systems govern the transfer of electricity between the traction motors and the rechargeable battery cells that supply the requisite power for operating many hybrid-electric and full-electric powertrains. To provide the power capacity and energy density needed to propel a vehicle at desired speeds for desired ranges, a contemporary traction battery pack may group multiple battery cells (e.g., 8-16+ cells/stack) into individual battery modules (e.g., 10-40+ modules/pack), which are electrically interconnected with one another and mounted onto the vehicle chassis, e.g., by a battery pack housing or support tray. Located on a battery side of the HV electric system is a front-end DC-to-DC power converter that is electrically connected to the battery pack(s) in order to boost the level of voltage supplied to a main DC bus and a power inverter module (PIM). A high-frequency bulk capacitor may be arranged across the positive and negative rails of the main DC bus to provide electrical stability and store supplemental electrical energy. A dedicated Electronic Battery Control Module (EBCM), through collaborative operation with a Powertrain Control Module (PCM) and each motor's power electronics package, may govern operation of the battery pack(s) and traction motor(s).

As hybrid and electric vehicles become more prevalent, infrastructure is being developed and deployed to make day-to-day use of such vehicles feasible and convenient. Electric vehicle supply equipment (EVSE) for recharging electric-drive vehicles comes in many form factors, including residential electric vehicle charging stations (EVCS) that are purchased and operated by a vehicle owner (e.g., installed in the owner's garage), publicly accessible EVCS offered by public utilities or private retailers (e.g., at municipal or commercial charging facilities), and advanced high-voltage, fast-charging stations used by manufacturers, dealers, and service stations (e.g., multi-coupler 360+kW superchargers). Plug-in-type hybrid and electric vehicles, for instance, may be recharged by physically connecting a charging cable of the EVSE to a complementary charging port of the vehicle. By comparison, wireless AC charging systems utilize electromagnetic field (EMF) induction to provide vehicle charging capabilities without the need for charging cables and cable ports. Direct-current fast-charging (DCFC) EVSE dramatically increase the rate of energy transfer (e.g., from 120/240 VAC to 480 VDC) with a concomitant reduction in the time required to charge a vehicle's traction batteries (e.g., from ˜4-8 hours to ˜15-40 mins).

Presented herein are HV electrical system architectures for V2V charging of vehicle batteries, methods for manufacturing and methods for operating such systems, and vehicles equipped with such systems. By way of illustration, and not limitation, an electric-drive vehicle contains an HV electrical architecture with a main DC bus that connects a RESS, which contains one or more rechargeable traction battery packs, and an electrified propulsion system, which contains one or more traction motors. While not per se limited, disclosed concepts may be particularly relevant to a mid-duty (MD) or heavy-duty (HD) plug-in FEV truck with an 800V dual-independent drive unit (DIDU) spit-axle powertrain and a 450-750 kilowatt-hour (kWh) dual-pack RESS (e.g., depending on gross vehicle weight (GVW) and desired range). Integrated into the HV electrical system is an onboard (or offboard) DC-DC converter that provisions V2V energy exchanges using, for example, a Society of Automotive Engineers (SAE) J3253 electric power take-off (ePTO) connector for charge-communication handshakes. The vehicle may also be equipped with a separate megawatt charging system (MCS) charging inlet port and/or an optional alternating-current (AC) output interface. The smart integrated DC-DC converter is operable to step-up or step-down power input received by the host vehicle's RESS from a donor vehicle based on the host vehicle RESS state-of-charge (SOC), RESS voltage, RESS power limits, etc.

During normal DCFC events, the integrated DC-DC converter may operate in a bypass mode in which DC power input is passed through the converter unadulterated, e.g., to eliminate a need for external contactors or an HV-cable splice that provides an additional DCFC path. If desired, the DC-DC converter may be liquid cooled and, thus, integrated with the HV power-electronics (PE) cooling loop such that the loop works during V2V charge-sharing mode. The system may employ a J3253 controller area network (CAN) based protocol with a low-voltage (LV) upfitter module to enable communication requests and, optionally, to provide a gateway to the host vehicle's Software-Defined Vehicle (SDV) network. An upfitter module may be utilized for V2V DCFC to enable an ePTO-connector based solution or multiple upfitter modules may be utilized, e.g., if there is no existing ePTO mode. For onboard DC-DC converter architectures, dynamic handshaking of voltages and currents for voltage regulation on the donor vehicle may be added to an ePTO solution. For offboard DC-DC converter architectures, the V2V DCFC PE package may be housed inside an external “V2V box”. Isolation monitoring of the donor vehicle and/or the host vehicle may be incorporated into a DCFC port monitoring/control module.

Aspects of this disclosure are directed to HV electrical system architectures that provision both standard and V2V DCFC charging for rechargeable battery cells of electric-drive vehicles. In an example, a high-voltage electrical system is presented for a motor vehicle that is equipped with one or more traction motors, such as polyphase permanent magnet (PM) or field-wound separately excited (SE) motors, and one or more rechargeable battery units, such as a dual pack RESS that contains stacked arrays of rechargeable battery cells (e.g., prismatic, pouch, or cylindrical lithium-ion cells). The HV electrical system contains a main HV electrical busbar rail system (“bus”), at least one DCFC-compatible HV charging inlet port, and a DC-to-DC (DC-DC) power converter module. To enable HV power distribution, the main bus electrically connects the vehicle's propulsion traction motor(s) to the on-vehicle battery unit(s). The charging inlet, which may be in the nature of an 800V J3253 DCFC port, electrically mates with and receives direct-current power from respective DCFC cables of both a donor vehicle and a charging station. To modulate power input feeds, the DC-DC converter is interposed between and electrically connects the charging inlet port and the main HV bus. The DC-DC converter is operable in a bypass mode, in which the converter passes therethrough DC power received from the DCFC cable of the charging station, and a vehicle-to-vehicle (V2V) mode, in which the converter modulates DC power received from the DCFC cable of the donor vehicle.

Additional aspects of this disclosure are directed to electric-drive vehicles equipped with HV electrical systems that provision both EVCS DCFC and V2V DCFC for the vehicle's rechargeable battery cells. As used herein, the terms “vehicle” and “motor vehicle” may be used interchangeably and synonymously to reference any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles, motorcycles, farm equipment, watercraft, aircraft, e-bikes, etc. In an example, a motor vehicle includes a vehicle body with a passenger compartment, multiple road wheels mounted to the vehicle body (e.g., via corner modules coupled to a unibody or body-on-frame chassis), and other standard original equipment. For electric-drive vehicle applications, the vehicle's electrified powertrain employs one or more electric traction motors, which operate alone (e.g., for FEV powertrains) or in conjunction with an internal combustion engine assembly (e.g., for HEV powertrains), to selectively drive one or more of the road wheels and thereby propel the vehicle. Each motor is operatively connected to a resident RESS that contains a rechargeable battery assembly, which may be in the nature of a chassis-mounted HV traction battery pack or array of HV battery modules.

Continuing with the preceding discussion, the motor vehicle is also equipped with an HV electrical system that governs the exchange of electric power and signals between the vehicle's resident and remote electrical devices. The HV electrical system includes, for example, a main HV bus that electrically connects the vehicle's traction motor and rechargeable battery pack. Also mounted to the vehicle body is a charging inlet port that electrically mates with and receives DC power from respective DCFC cables of one or more donor vehicles and one or more DCFC charging stations. A DC-DC converter is interposed between and electrically connects the charging inlet port and the main HV bus. This DC-DC converter is structurally configured to operate in a bypass mode and a V2V mode. When in the bypass mode, the DC-DC converter passes therethrough DC power received from a DCFC cable of a charging station. When in the V2V mode, the DC-DC converter modulates DC power received from a DCFC cable of a donor vehicle.

Aspects of this disclosure are also directed to manufacturing workflow processes, computer-readable media, and control logic for making or for using any of the disclosed HV electrical systems and/or motor vehicles. In an example, a method is presented for assembling a high-voltage electrical system of a motor vehicle. This representative method includes, in any order and in any combination with any of the above and below disclosed options and features: attaching a main HV bus to the vehicle body; electrically connecting, via the main HV bus, the traction motor to the rechargeable battery assembly; attaching a charging inlet port to the vehicle body, the charging inlet port configured to electrically mate with and receive DC power from DC fast-charging cables of a donor vehicle and a charging station; attaching a DC-DC converter to the vehicle body; and electrically connecting, via the DC-DC converter, the charging inlet port and the main HV bus such that the DC-DC converter is electrically interposed between the charging inlet port and the main HV bus, the DC-DC converter being operable in a bypass mode, in which the DC-DC converter passes therethrough the DC power received from the DCFC cable of the charging station, and a vehicle-to-vehicle (V2V) mode, in which the DC-DC converter modulates the DC power received from the DCFC cable of the donor vehicle.

For any of the disclosed systems, methods, and vehicles, the DC-DC converter may contain a bypass (relay) switch that is selectively switchable, e.g., via electronic control signal, between a closed state and an open state. In this instance, transitioning the bypass switch to the closed state places the DC-DC converter in the bypass mode, whereas transitioning the bypass switch to the open state places the DC-DC converter in the V2V mode. As a further option, the DC-DC converter may contain at least one pair of electronic switches (e.g., paired semiconductor switches) that are electrically connected in series with each other and arranged parallel to the bypass switch. For multi-pair switch configurations, each switch pair is electrically connected in parallel with the other switch pairs. As another option, a capacitor may be electrically connected in parallel with the electronic switch pairs and arranged parallel to the bypass switch. Moreover, one or more electric resistors may be electrically connected in series with the pairs of electronic switches and arranged parallel to the bypass switch.

For any of the disclosed systems, methods, and vehicles, a battery disconnect unit (BDU) may be interposed between and electrically connect the DC-DC converter and the rechargeable battery assembly. In this instance, the BDU contains a pair of (first and second) relay switches that are switchable between a closed state, in which the BDU connects the DC-DC converter and, thus, the charging inlet port to the battery assembly, and an open state, in which the BDU disconnects the DC-DC converter and charging inlet from the battery assembly. For some system architectures, the HV electrical system may include an AC output interface that outputs AC power from the rechargeable battery assembly (e.g., one or more 110-125V/15-20 A electrical sockets). In this instance, the charging inlet port is interposed between and electrically connects the AC output interface and the DC-DC converter such that the DC-DC converter electrically connects to the AC output interface to the main HV bus.

For any of the disclosed systems, methods, and vehicles, the HV electrical system may contain an MCS charging inlet port that is electrically connected to the main HV bus and operable to electrically mate with and receive electrical power from an MCS connector plug (e.g., cable delivering at least 3.0-4.5 MW/2500-3000 A/1000-1250 VDC). In this instance, a BDU may be interposed between the MCS charging inlet port and the rechargeable battery assembly; the BDU contains a pair of (first and second) relay switches that are switchable between closed and open states to thereby selectively disconnect the MCS charging inlet port from the battery assembly. An onboard charging module (OBCM) may be electrically connected to the charging inlet port and operable to regulate transfer of DC power received from a DCFC cable. As another option, an accessory power module (APM) may be electrically connected to the charging inlet port and operable as a DC-DC power converter to selectively decrease DC electric power from a first voltage level to a second voltage level at which are rated one or more accessory loads of the motor vehicle.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with an electrified powertrain, a rechargeable battery pack, and a high-voltage electrical system for V2V DCFC smart charging of the battery pack cells in accord with aspects of the present disclosure.

FIG. 2 is a schematic diagram illustrating an example of a vehicle HV electrical system with an integrated DC-DC converter interposed between a DCFC charge port and a main HV bus for V2V DCFC in accord with aspects of the present disclosure.

FIG. 3 is a schematic diagram illustrating another example of a vehicle HV electrical system with an integrated DC-DC converter interposed between a DCFC charge port and a main HV bus for V2V DCFC in accord with aspects of the present disclosure.

FIG. 4 is a flowchart illustrating a representative vehicle control method for automating V2V DCFC between a recipient vehicle and a donor vehicle, which may correspond to memory-stored instructions that are executable by a resident or remote controller, control-logic circuit, programmable control unit, or other integrated circuit (IC) device or network of devices in accord with aspects of the disclosed concepts.

FIG. 5 is a schematic diagram illustrating a representative HV electrical system of a donor vehicle operatively coupled to an offboard DC-DC converter for V2V DCFC charging of a recipient vehicle in accord with aspects of the present disclosure.

FIG. 6 is a flowchart illustrating another representative vehicle control method for automating V2V DCFC between a recipient vehicle and a donor vehicle, which may correspond to memory-stored instructions that are executable by a resident or remote controller, control-logic circuit, programmable control unit, or other IC device or network of devices in accord with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this Detailed Description, unless specifically disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

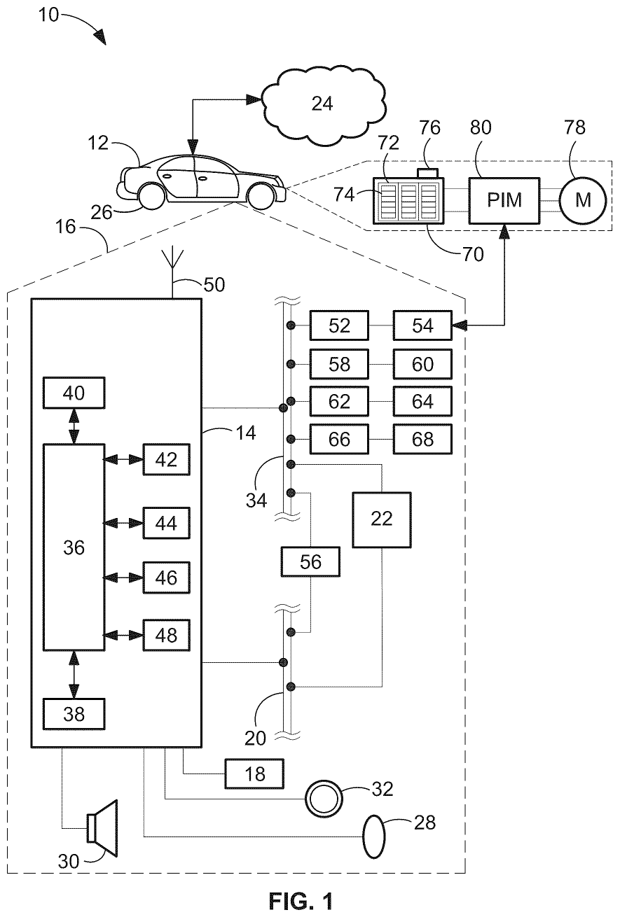

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into an FEV powertrain powered by a single-pack RESS should be appreciated as a non-limiting implementation of disclosed features. As such, it will be understood that aspects and features of this disclosure may be applied to other powertrain systems and RESS architectures, incorporated into any logically relevant type of motor vehicle, and utilized for both automotive and non-automotive applications alike. Moreover, only select components of the motor vehicles and HV electrical systems are shown and described in additional detail herein. Nevertheless, the vehicles and electrical systems discussed below may include numerous additional and alternative features, and other available peripheral components, for carrying out the various methods and functions of this disclosure.

The representative vehicle 10 of FIG. 1 is originally equipped with a centerstack telecommunications and information (“telematics”) unit 14 that wirelessly communicates, e.g., via cell towers, satellite service, etc., with a remotely located cloud computing host service 24 (e.g., ONSTAR®). Other in-vehicle hardware components 16 shown in FIG. 1 include, as non-limiting examples, an electronic video display device 18, a microphone 28, audio speakers 30, and assorted user input controls 32 (e.g., buttons, knobs, switches, touchscreens, etc.). These hardware components 16 function as a human/machine interface (HMI) that enables a user to communicate with the telematics unit 14 and other components both resident to and remote from the vehicle 10. Microphone 28, for instance, provides occupants with means to input verbal commands. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is the network connection interface 34, suitable examples of which include twisted pair/fiber optic Ethernet switches, parallel/serial communications buses, local area network (LAN) interfaces, controller area network (CAN) interfaces, and the like. Network connection interface 34 enables vehicle hardware 16 to send and receive signals with one another and with systems and subsystems both onboard and offboard the vehicle body 12. This allows the vehicle 10 to perform assorted vehicle functions, such as modulating powertrain output, activating a vehicle brake system, controlling vehicle steering, regulating charge and discharge of vehicle batteries, and other automated functions. For instance, telematics unit 14 may receive and transmit signals to/from a Powertrain Control Module (PCM) 52, an Onboard Charging Module (OBCM) 54, an Electronic Battery Control Module (EBCM) 56, a Steering Control Module (SCM) 58, a Brake System Control Module (BSCM) 60, and assorted other vehicle ECUs.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to an integrated circuit (IC) real-time clock (RTC) 42 and one or more electronic memory devices 38, each of which may take on the form of a CD-ROM, solid-state drive (SSD) memory, hard-disk drive (HDD) memory, semiconductor memory, etc.

Long-range communication (LRC) capabilities with offboard devices may be provided via a cellular communication component, a navigation and location component (e.g., global positioning system (GPS) transceiver), or a wireless modem, all of which are collectively represented at 44. Short-range communication (SRC) may be provided via a close-range wireless communication device 46 (e.g., a BLUETOOTH® unit), a dedicated short-range communications (DSRC) component 48, and/or a dual antenna 50. It should be understood that the vehicle 10 may be implemented without one or more of the above-listed components or, optionally, may include additional components and functionality as desired for a particular end use. The communications devices described above may provision data exchanges as part of a periodic broadcast in a vehicle-to-vehicle (V2V) communication system or a vehicle-to-everything (V2X) communication system.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of on-vehicle sensors may be adapted, singly or collectively, to a given vehicle platform for achieving a desired level of autonomous vehicle operation.

To propel the motor vehicle 10, an electrified powertrain is operable to generate and deliver tractive torque to one or more of the vehicle's drive wheels 26. The powertrain is represented in FIG. 1 by an electric traction motor 78 that is connected to a rechargeable energy storage system (RESS), which may be in the nature of a chassis-mounted traction battery pack 70. The battery pack 70 may contain one or more battery modules 72 each housing a group of electrochemical battery cells 74, such as lithium-ion or lithium-polymer battery cells of the pouch, can, or prismatic type. One or more electric machines, such as an adjustable-speed, multiphase SEM motor/generator (M) unit 78, draw electrical power from and, optionally, deliver electrical power to one or more rechargeable battery units, such as traction battery pack 70. An HV electrical system with a power inverter 80 electrically connects the battery pack 70 to the motor/generator unit(s) 78 and modulates the transfer of electrical current therebetween. The battery pack 70 may be configured such that module management, cell sensing, and module-to-host communications functionality is integrated directly into each module 72 and performed wirelessly via a wireless-enabled cell monitoring unit (CMU) 76.

Discussed below are high-voltage electrical system architectures that provision both standard EVCS DCFC charging and smart V2V DCFC charging for rechargeable battery cells of electric-drive vehicles. By way of example, and not limitation, a motor vehicle may be equipped with an HV electrical system that uses a smart integrated DC-DC converter to step-up or step-down voltage levels of DC power input received by a subject (host) vehicle from a third-party (donor) vehicle. Modulation by the DC-DC converter of the received DC power may be based on the host RESS's SOC, SOH, requested voltage level, requested power, etc., which may be communicated via a suitable connector (e.g., J3253 ePTO connector plug) to the vehicle's OBCM. An optional MCS charging inlet port may be integrated into the EV electrical system on a separate line and, if desired, may be electrically connected to the main HV bus by a separate DC-DC converter.

The DC-DC converter may be disposed between and, thus, function as the electrical interface for the DCFC charging port and the vehicle's main HV bus. During vehicle propulsion and standard EVCS-based DCFC, the DC-DC converter may operate in a bypass mode in which DC power input is passed-through the converter unadulterated, e.g., to eliminate the need for an external contactor or an HV cable splice to provide an additional DCFC path. Furthermore, the DC-DC converter may tale on a liquid-cooled design and, thus, may be integrated with the PE cooling loop such that the loop works even during charge-sharing mode. For at least some implementations, the HV electrical system's integrated DC-DC converter is capable of at least about 50 kW to about 100 kW of continuous power with at least about 150 amps (A) to about 300 A continuous output current for operation over input voltages of at least about 350 volts (V) to about 850V and output voltages of at least about 150V to about 850V.

An optional HV electrical system architecture for a motor vehicle may be adapted for interfacing with an external DC-DC converter that is connected via a pair of ePTO power connector plugs to the host vehicle and the donor vehicle. A J3253 CAN-based protocol may employ an LV upfitter module that enables communication requests and provides a gateway to the vehicle's SDV network. In this example, V2V DCFC may utilize an upfitter module with an existing ePTO connector solution or an additional upfitter module if the vehicle does not have an existing ePTO mode. For onboard DC-DC converter architectures, dynamic handshaking of voltages and currents for voltage regulation on the donor vehicle may be added to an (existing or added) ePTO solution. For offboard DC-DC converter architectures, the V2V DCFC PE package may be housed in an external “V2V box” that is offboard from both the host and donor vehicles. Isolation monitoring on the donor vehicle and/or the host vehicle may be incorporated into a DCFC port monitoring/control module. Charging control codes may be incorporated in a charging hardware module (CHM) to implement a regulated discharge function of the vehicle.

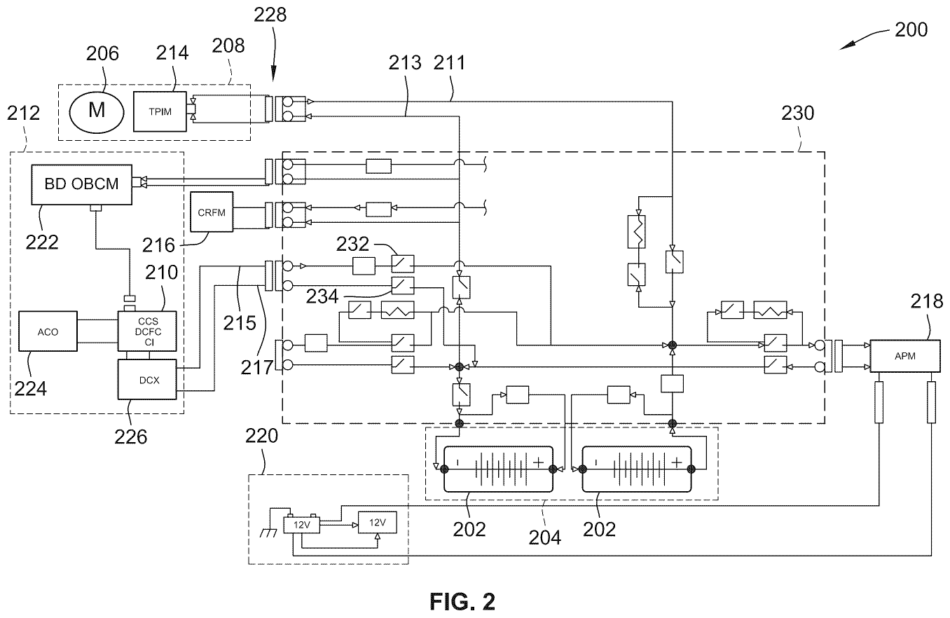

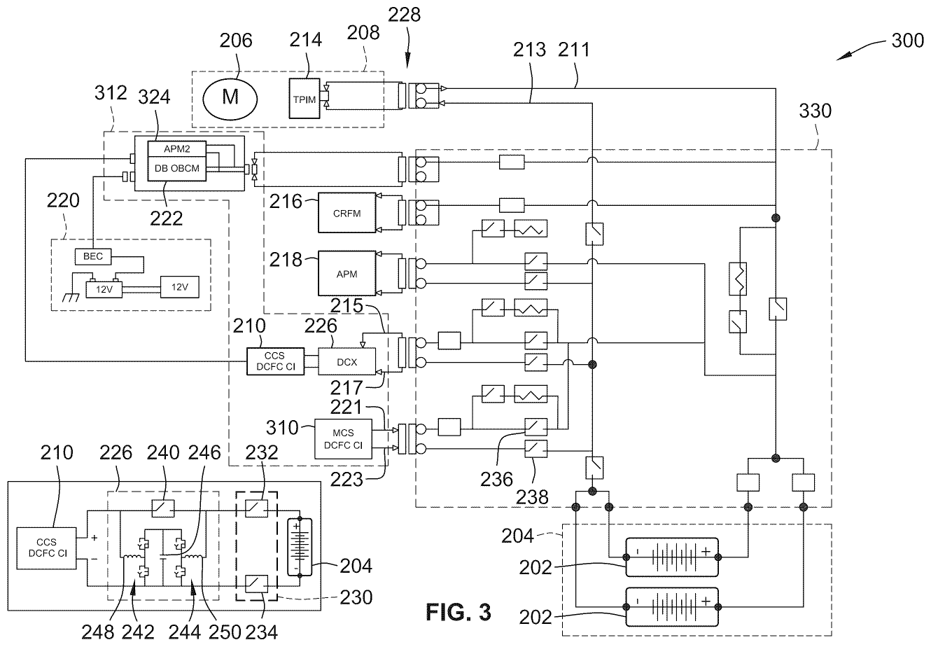

Turning next to FIGS. 2 and 3, wherein like reference numbers are used to designate the same or similar components throughout the views, there are shown two non-limiting examples of high-voltage electrical systems, respectively designated at 200 and 300, that provision both EVCS DCFC and V2V DCFC for battery cells of motor vehicles, such as traction battery pack 70 of electric-drive vehicle 10 of FIG. 1. Although differing in appearance, it is envisioned that any of the features and options described above with reference to the vehicle 10 of FIG. 1 may be incorporated, singly or in any combination, into the HV electrical systems 200 and 300 of FIGS. 2 and 3, and vice versa. By way of example, each HV electrical system 200, 300 connects one or more rechargeable traction battery packs 202 of a rechargeable energy storage system (RESS) 204 to one or more electric traction motors (M) 206 of an electrified powertrain (EP) 208 and to a combined charging standard (CCS) DCFC charging inlet (CI) 210 of a battery charging system (BCS) 212. While illustrated with two battery packs 202, a single motor (M) 206, and a single CI port 210 (FIG. 2) or dual CI ports 210, 310 (FIG. 3), disclosed HV electric system architectures may be adapted for vehicle powertrains with multiple motors, RESS assemblies with greater or fewer than two packs, and BCS with a single or multiple charging inlets of any suitable design. Moreover, the illustrated system architectures have been greatly simplified for purposes of brevity and clarity; nevertheless, these systems may include additional and alternative hardware and other available peripheral components without departing from the intended scope of this disclosure.

Acting as a primary load of current draw, each motor 206 may be embodied as an integrated electric drive unit (DU) containing a polyphase or induction motor generator unit (MGU), a multi-ratio gearbox, and a power electronics (PE) package. Acting as a primary interface for an offboard charge point, each charging inlet 210 may be embodied as a charging cable connector port that is compatible for wired connection with cable plug of a Level 3 DCFC vehicle charging station. RESS 204 of FIG. 2 is portrayed as a dual-pack variant with two high-capacity, deep-cycle traction battery packs 206 that are connected across positive and negative bus rails 211 and 213, respectively, of a battery-side, high-voltage DC bus. Each battery pack 206 has corresponding cathode/positive (+) and anode/negative (−) terminals that respectively couple the pack to the positive and negative bus rails 211, 213. Reference to either terminal as “anode” or “cathode” or, for that matter, as “positive” or “negative” does not limit the battery terminals to a particular polarity as the system polarity may change depending on whether the battery packs 206 are being operated in a charge mode or a discharge mode. To that end, reference to one feature as “upstream” or “downstream” from another feature will depend on the charge/discharge state of the battery and, thus, the flow direction of current across the electrical system.

The exemplary system architectures described below enable improved high-power connect and smart charging of the various HV system loads using both EVCS-based DCFC and V2V-based DCFC. As indicated above, the HV electrical systems 200 and 300 of FIGS. 2 and 3, may be bifurcated into two primary circuit loops: a first (main) circuit loop that electrically connects the RESS 204 to the electrified powertrain 208; and a second (DCFC) circuit loop that is parallel to the first circuit loop and electrically connects the RESS 204 to the battery charging system 212. Representative electrical loads on the main loop of the electrical systems 200, 300 may include, but are not limited to, one or more electric traction motors 206, one or more traction power inverter modules (TPIM) 214, a condenser, radiator, fan module (CRFM) 216, and a master accessory power module (APM) 218. The TPIM 214 is operable to convert DC power output from the RESS 204 to AC power for operating the motor(s) 206, e.g., when operating in an electrified propulsion mode, and to convert AC power generated by the motor(s) 206 to DC power for recharging the RESS 204, e.g., when operating in a regenerative braking mode. Comparatively, the CRFM 216 may provide automated control of one or more heat exchanging devices and one or more coolant loops in an integrated active thermal management (ATM) system for the heat-generating components of the HV system. The master APM 218 may function as a DC-DC power converter that modulates DC electric power from a high (first) voltage level to a low (second) voltage level at which are rated one or more accessory loads of the HV system, such as a starting, lighting, and ignition (SLI) battery module 220. Other electrical loads on the main circuit loop may include, but are certainly not limited to, an air conditioning electric compressor (ACEC) and a RESS heater (not shown).

Representative electrical loads on the DCFC loop of the electrical systems 200, 300 may include, but are not limited to, one or more charging inlets 210, a bi-directional onboard charging module (BD OBCM) 222, an alternating-current output (ACO) interface 224, and a DC-to-DC (DC-DC) power converter (DCX) 226. The charging inlet 210 electrically mates with and receives DC power from respective DC fast-charging cables/plugs of one or more donor vehicles (e.g., V2V DCFC charging event) and one or more charging stations (e.g., EVCS DCFC charging event). When battery charging is desired, the OBCM 222 may monitor and selectively govern the charging rate, current, voltage, start/stop times, etc., of a wired or wireless charging event. The OBCM 222 may also function as a low-voltage DC-to-AC converter to convert a DC voltage from the RESS 204 into an AC voltage suitable for use by the ACO interface 224. The ACO interface 224, which may be embodied as one or more 110-125V/15-20 A electrical sockets, outputs AC power from the RESS 204 and modulated by the BD OBCM 222. In addition to the CCS-type DCFC charging inlet 210, the DCFC loops of the HV electrical systems 200, 300 may also incorporate an electric power take-off (ePTO) connector (e.g., on a “Vehicle Rear” section of the architecture) and/or a megawatt charging system (MCS) charging inlet 310 (FIG. 3) (e.g., on a “Vehicle Front” section of the architecture). Other optional hardware may include, but is certainly not limited to, a secondary accessory power module (APM2) 324 (FIG. 3) that may be integrated with the OBCM 222, and a vehicle onboard power outlet (V2LIM) module (e.g., 120V, 240V, 7.2 kW sockets).

To enable both EVCS-based and V2V-based DCFC via a shared charging inlet, a DC-DC converter 226 is electrically interposed between and, thus, electrically connects the charging inlet port 210 and a main HV electrical busbar rail system (“bus”) 228. The main HV bus 228 may contain at least a pair of positive and negative HV main bus rails 215 and 217, respectively, that cooperatively electrically connect the rechargeable battery pack(s) 202 to both the traction motor(s) 206 and the charging inlet port 210. The smart integrated DC-DC converter 226 is operable to step-up or step-down power input received by the host vehicle's RESS 204 from a donor vehicle and/or an external charging station based, for example, on the host vehicle RESS's state-of-charge (SOC), RESS voltage, RESS power limits, etc. The CI port 210 of FIG. 2 is interposed between and electrically connects the ACO interface 224 and the DC-DC converter 226. In the system architecture of FIG. 2, the DC-DC converter 226 acts as an electrical intermediary that arbitrates the transmission of AC power and DC power to and from the main bus 228 and both the CCS DCFC CI 210 and the ACO 224. During a battery charging event, the CI port 210 is fluidly upstream from and directly connected to the DCX 226 such that all power input received via the CI port 210 is passed through the DCX 226. To help reduce system cost and complexity, the CI port 210 may lack an alternative conduit for passing DC power to the main HV bus 228 and, thus, the RESS 204.

In order to eliminate the need for a junction box, an HV-cable splice, additional contactors, etc., the DC-DC converter 226 may be designed to operate in both a bypass mode and a V2V mode. When in the bypass mode, such as during normal vehicle propulsion or during standard DCFC charging, the DC-DC converter 226 contains internal circuitry that passes therethrough DC power received by the CI port 210 from a DCFC cable of an EVCS to the main HV bus 228. When in the V2V mode, such as during a V2V DCFC charging, the DC-DC converter 226 contains internal circuitry that modulates the DC power received from a DCFC cable of a donor vehicle. To provide fast-actuation current switching with resettable bidirectional short-circuit protection, a battery disconnect unit (BDU) 230 may be interposed between the DC-DC converter 226 and the rechargeable battery pack(s) 202 within the RESS 204. The BDU 230 of FIG. 2 contains a pair of controller-actuable relay switches 232 and 234 that are switchable between closed and open relay states to thereby selectively disconnect the DCX 226 and, thus, the CI 210 and ACO 224 from the RESS 204.

Similar to the HV electrical system 200 of FIG. 2, a DC-DC converter 226 is integrated into the HV electrical system 300 of FIG. 3, electrically interposed between and electrically connecting the charging inlet port 210 and the main HV bus 228. In this example architecture, however, an MCS DCFC charging inlet (CI) port 310 is electrically connected via positive and negative main bus branch rails 221 and 223 to the main HV bus 228. Unlike a CCS or ePTO inlet, the MCS CI port 310 electrically mates with and thereby receives electrical power from an MCS connector plug and cable, e.g., that delivers DC power at about at least 3.0-4.5 MW, 2500-3000 A and 1000-1250 VDC. In FIG. 3, a battery disconnect unit (BDU) 330 is interposed between the RESS 204 and both the CCS DCFC CI 210 and the MCS DCFC CI 310. In addition to the relay switches 232 and 234 for DCX 226, the BDU 330 of FIG. 3 contains another pair of controller-actuable relay switches 236 and 238 that are switchable between closed and open relay states to thereby selectively disconnect the MCS CI port 310 from the RESS 204.

Inset within FIG. 3 is a simplified schematic diagram of the unidirectionally controlled, standalone DC-DC converter 226 that electrically connects and regulates the exchange of DC power between the DCFC CI port 210 and the rechargeable battery pack(s) 204. To provision the bypass and V2V operating modes described above, the DC-DC converter 226 contains a controller-actuable bypass relay switch 240 that is selectively switchable between closed and open relay states. Transitioning the bypass switch 240 to the closed state, for example, places the DC-DC converter 226 in the bypass mode such that a voltage input is passed through the DCX 226 unadulterated. Transitioning the bypass switch 240 to the open state, on the other hand, places the DC-DC converter 226 in the V2V mode, e.g., to step-up a voltage input received from a donor vehicle.

In order to step-up or step-down power input received by the host vehicle's CCS DCFC CI 210, the DCX 226 contains a CI-side (first) switch pair 242 (“left switch leg”) with at least two electronic switches that are electrically connected in series with each other and arranged parallel to (but not electrically connected for sharing current with) the bypass switch 240. In the same vein, a BDU-side (second) switch pair 244 (“right switch leg”) contains at least two electronic switches that are electrically connected in series with each other, in parallel with the switches of the first switch pair 242, and arranged parallel to (but not electrically connected for sharing current with) the bypass switch 240. The internal switches of the DC-DC converter 226 may be embodied as electro-mechanical contactors or, in optional embodiments, as solid-state switches, such as IGBTs, MOSFETs, or other switchable semiconductor-based components. In accord with the illustrated example, a DCX capacitor 246 is electrically connected, e.g., on a “center leg”, in parallel with both switch pairs 242, 244 and arranged parallel to the bypass switch 240. Two (first and second) DCX resistors 248 and 250 are electrically connected in series with each other and with the two switch pairs while also arranged parallel to the bypass switch 240.

In FIGS. 2 and 3, the unidirectional, standalone DC-DC converter 226 may have wide input and output operating voltage ranges (e.g., at least about 350V to 1000V IN; at least about 150V to 1000V OUT), e.g., to accommodate the varying charging capabilities of heterogeneous donor vehicles. It may be desirable, for at least some applications, that the DC-DC converter 226 be a non-isolated, buck-boost-type converter, an isolated DC-DC converter, or other suitable DC-to-DC converter topology. As previously noted, the DC-DC converter 226 may be designed such that it is only used during V2V charging; otherwise, the DCX may automatically default to bypass mode (e.g., using an internal DCX bypass switch during EVCS-based DCFC charging). This bypass switch 240 carries DCFC current during the normal DCFC charging mode of the RESS 204. The DC-DC converter 226 directly connects to the charging inlet port 210 and may use three (3) relay switches (two BDU relays and bypass relay integrated inside DC-DC Box).

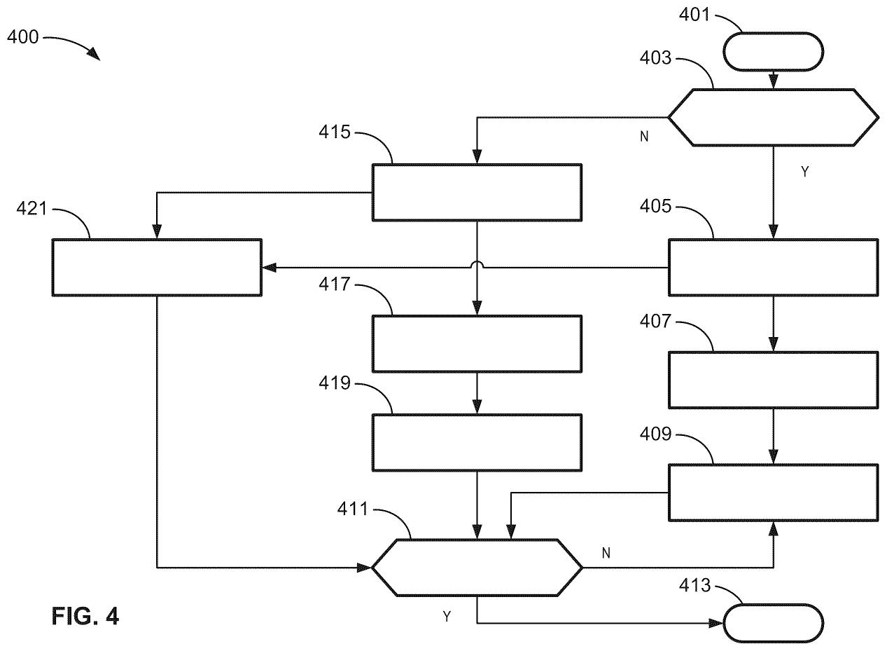

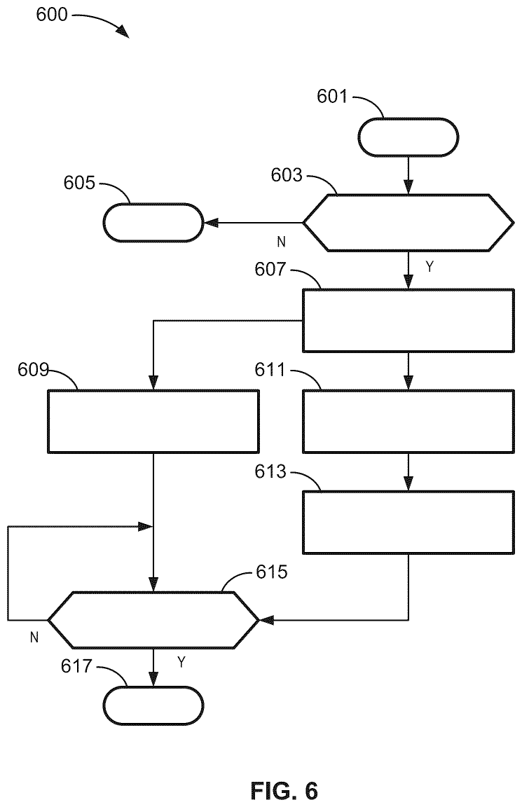

With reference next to the flow charts of FIGS. 4 and 6, there are presented improved methods 400 and 600, respectively, for automating V2V DCFC between a recipient vehicle and a donor vehicle, such as automobile 10 of FIG. 1, using an HV electrical system, such as HV electrical systems 200, 300 and 500 shown in FIGS. 2, 3 and 5. Some or all of the operations illustrated in FIGS. 4 and 6 and described in further detail below may be representative of algorithms that corresponds to non-transitory, processor-executable instructions that are stored, for example, in main or auxiliary or remote memory (e.g., memory device(s) 38 of FIG. 1), and executed, for example, by an electronic controller, processing unit, dedicated control module, logic circuit, or other module or device or network of modules/devices (e.g., resident CPU 36 and/or remote host service 24 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 400 begins at START terminal block 401 of FIG. 4 with memory-stored, processor-executable instructions for a programmable controller or control module or similarly suitable processor to call up an initialization procedure for a vehicle charging control protocol. At CHARGING MODE decision block 403, the method 400 determines whether or not the subject vehicle is in a charge mode or a discharge mode. Upon determining that the subject vehicle is in the discharge operating mode (Block 403=YES), method 400 advances to SUPPLY HANDSHAKE process block 405 and enables a vehicle Supply Equipment Communication Controller (SECC) handshake. Upon completing the SECC handshake whereby the power supplying vehicle is communicatively paired with the power recipient vehicle, method 400 executes CONTROL RING process block 407 that enables a control ring for governing a DC-DC V2V discharge mode. Advancing to POWER TRANSFER process block 409, method 400 regulates the transfer of DC power through a DC-DC converter to the recipient vehicle. At TARGET decision block 411, the method 400 determines whether or not a target SOC and/or a target energy transfer amount has been reached. If not (Block 411=NO), method 400 may loop back to process block 409 and continue the V2V charging operation. If the target SOC/energy transfer has been reached (Block 411=YES), method 400 may advance to STOP terminal block 413 and temporarily terminate or, optionally, may loop back to terminal block 401 and run in a continuous loop.

Upon determining that the subject vehicle is in the charging operating mode (Block 403=NO), method 400 advances to CHARGING MODE process block 415 and executes preliminary protocols for receiving DC power. Method 400 proceeds from process block 415 to CHARGE HANDSHAKE process block 417 and enables an Electric Vehicle Communication Controller (EVCC) handshake. Upon completing the EVCC handshake whereby the power recipient vehicle is communicatively paired with electric vehicle supply equipment, method 400 executes CONVERTER BYPASS process block 419 and bypasses the integrated DC-DC converter. After completing the DC-DC converter bypass, method 400 determines whether or not a target SOC and/or a target energy transfer amount has been reached at TARGET decision block 411. Concurrent with vehicle charging, method 400 may execute BMS CHARGE TRACKING process block 421 and monitor a predefined set of charging parameters, such as a voltage (V), current (i), state-of-charge (SOC), and other related sensed outputs.

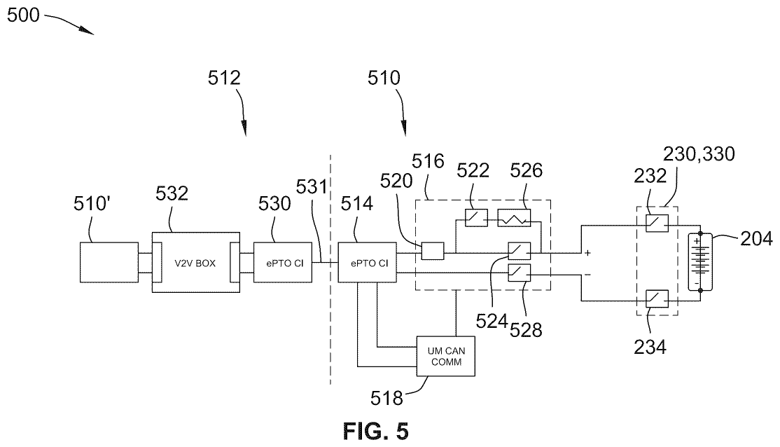

Referring next to FIG. 5, there is shown a simplified schematic diagram of a representative HV electrical system 500 of a donor vehicle 510 operatively coupled to an offboard DC-DC converter subsystem 512 for V2V DCFC charging of a recipient vehicle 510′, which may contain one of the HV electrical systems 200 and 300 of FIGS. 2 and 3. In this example, the donor vehicle 510 contains an electric power take-off connector interface (ePTO CI) 514, such as an SAE J3253 plug connection port, that is electrically connected to an auxiliary junction box 516 and upfitter module (UM CAN Comm) 518. The auxiliary junction box 516 of FIG. 5 contains a junction fuse 520 in serial power-flow communication with first and second junction switches 522 and 524, respectively, and a junction resistor 526. The junction resistor 526 is connected in series with the first junction switch 522 and in parallel with the second junction switch 524. A third junction switch 528 cooperates with the first and second junction switches 522, 524 (i.e., one at a time) to selectively connect and disconnect the ePTO CI 514 to the BDU 230, 330 and, thus, the RESS 204. UM CAN Comm 518 may contain a suitable CAN-type interface, input-output (I/O) configuration logic, and a handshake control module.

Donor vehicle ePTO CI 514 operatively couples to a V2V ePTO CI 530 of the offboard DC-DC converter subsystem 512 via a complementary cable and plug 531 (e.g., SAE J3253 plug). The V2V ePTO CI 530, in turn, is operatively coupled to the HV electrical system of the recipient vehicle 510′ via a V2V Box 532. This V2V box 532 may contain a DC-DC converter through which is passed DC power from the donor vehicle 510 to the recipient vehicle 510′, as described above with respect to the DCX 226 of FIGS. 2 and 3. The V2V box 532 may also contain an integrated thermal management system, an array of control sensors, a human-machine interface (HMI), an external communication module, a V2V system controller, and a vehicle communication interface. Optionally, the V2V Box 532 may be originally equipped with at least two cable-and-plug connectors 531 for operatively coupling with both the donor and recipient vehicles 510, 510′. The aforementioned system architecture 500 enables V2V charging using an offboard unidirectionally controlled V2V box 532. The standalone DC-DC converter contained within the V2V box 532 may take on assorted topologies. The EPTO connector interface allows for V2X discharge current and the exchange of handshaking signals that allow for specific signal exchanges like voltage, current/power, energy, SOC etc.

FIG. 6 illustrates a representative vehicle control method for automating V2V DCFC between a recipient vehicle and a donor vehicle using the DC-DC converter subsystem 512 of FIG. 5. Method 600 begins at START terminal block 601 of FIG. 6 with memory-stored, processor-executable instructions for a programmable controller or control module or similarly suitable processor to call up an initialization procedure for a vehicle charging control protocol. At CHARGING MODE decision block 603, the method 600 determines whether or not the subject vehicle is in an ePTO V2V discharging mode. If not (Block 603=NO), method 600 may proceed to EXIT terminal block 605 and temporarily terminate. Upon determining that the subject vehicle is in the V2V discharging mode (Block 603=YES), method 600 advances to OFFBOARD HANDSHAKE process block 607 and enables a vehicle ePTO handshake, e.g., whereby the power supplying “donor” vehicle is communicatively paired with the offboard V2V Box and, through the Box, with a power-receiving “recipient” vehicle.

At BMS CHARGE TRACKING process block 609, method 600 monitors a predefined set of charging parameters, such as a charging voltage, a charging current, a state-of-charge of the recipient vehicle's RESS and/or the donor vehicle's RESS, and other related sensed outputs. Concurrent with process block 609, method 600 may execute UPFITTER MODULE process block 611 and enable communication and signal exchanges with one or more upfitter modules. Advancing to POWER TRANSFER process block 613, method 600 regulates the transfer of DC power through an offboard DC-DC converter to the recipient vehicle. At TARGET decision block 615, the method 600 determines whether or not a target SOC and/or a target energy transfer amount has been reached. If not (Block 615=NO), method 600 may run in a continuous loop until these target metrics are achieved. If the target SOC/energy transfer has been reached (Block 615=YES), method 600 may advance to STOP terminal block 617 and temporarily terminate or, optionally, may loop back to terminal block 601 and run in a continuous loop.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A high-voltage (HV) electrical system for a motor vehicle with a traction motor and a rechargeable battery assembly, the HV electrical system comprising:
a main HV bus configured to electrically connect the traction motor and the rechargeable battery assembly;
a charging inlet port configured to electrically mate with and receive direct-current (DC) power from DC fast-charging (DCFC) cables of a donor vehicle and a charging station; and
a DC-to-DC (DC-DC) converter interposed between and electrically connecting the charging inlet port and the main HV bus, the DC-DC converter being operable in a bypass mode, passing therethrough DC power from the DCFC cable of the charging station, and a vehicle-to-vehicle (V2V) mode, regulating DC power received through the DCFC cable of the donor vehicle.

2. The HV electrical system of claim 1, wherein the DC-DC converter includes a bypass switch switchable between a closed state, which places the DC-DC converter in the bypass mode, and an open state, which places the DC-DC converter in the V2V mode.

3. The HV electrical system of claim 2, wherein the DC-DC converter further includes a first pair of electronic switches electrically connected in series with each other and arranged parallel to the bypass switch.

4. The HV electrical system of claim 3, wherein the DC-DC converter further includes a second pair of electronic switches electrically connected in series with each other, in parallel with the first pair of electronic switches, and arranged parallel to the bypass switch.

5. The HV electrical system of claim 4, wherein the DC-DC converter further includes a capacitor electrically connected in parallel with the first and second pairs of electronic switches and arranged parallel to the bypass switch.

6. The HV electrical system of claim 5, wherein the DC-DC converter further includes first and second resistors electrically connected in series with the first and second pairs of electronic switches.

7. The HV electrical system of claim 1, further comprising a battery disconnect unit (BDU) interposed between the DC-DC converter and the rechargeable battery assembly, the BDU containing first and second relay switches switchable between closed and open states to selectively disconnect the DC-DC converter from the rechargeable battery assembly.

8. The HV electrical system of claim 1, further comprising an alternating-current (AC) output interface configured to output AC power from the rechargeable battery assembly, the charging inlet port interposed between and electrically connecting the AC output interface and the DC-DC converter.

9. The HV electrical system of claim 1, further comprising a megawatt charging system (MCS) charging inlet port electrically connected to the main HV bus and configured to electrically mate with and receive electrical power from an MCS connector.

10. The HV electrical system of claim 9, further comprising a battery disconnect unit (BDU) interposed between the MCS charging inlet port and the rechargeable battery assembly, the BDU containing first and second relay switches switchable between closed and open states to selectively disconnect the MCS charging inlet port from the rechargeable battery assembly.

11. The HV electrical system of claim 1, further comprising an onboard charging module (OBCM) electrically connected to the charging inlet port and configured to regulate receipt of the DC power from the DCFC cables.

12. The HV electrical system of claim 1, further comprising an accessory power module (APM) electrically connected to the charging inlet port and configured as a DC-DC power converter operable to decrease DC electric power from a first voltage level to a second voltage level at which are rated one or more accessory loads of the motor vehicle.

13. A motor vehicle comprising:
a vehicle body;
a plurality of road wheels attached to the vehicle body;
a traction motor mounted to the vehicle body and operable to drive one or more of the road wheels to thereby propel the motor vehicle;
a rechargeable battery pack mounted to the vehicle body and operable to power the traction motor; and
a high-voltage (HV) electrical system, including:
a main HV bus electrically connecting the traction motor and the rechargeable battery pack;
a charging inlet port configured to electrically mate with and receive direct-current (DC) power from DC fast-charging (DCFC) cables of a donor vehicle and a DCFC charging station; and
a DC-to-DC (DC-DC) converter interposed between and electrically connecting the charging inlet port and the main HV bus, the DC-DC converter being operable in a bypass mode, in which the DC-DC converter passes therethrough the DC power received from the DCFC cable of the charging station, and a vehicle-to-vehicle (V2V) mode, in which the DC-DC converter regulates DC power received through the DCFC cable from the donor vehicle.

14. A method of assembling a high-voltage (HV) electrical system of a motor vehicle, the motor vehicle including a vehicle body, a traction motor, and a rechargeable battery assembly, the method comprising:
attaching a main HV bus to the vehicle body;
electrically connecting, via the main HV bus, the traction motor to the rechargeable battery assembly;
attaching a charging inlet port to the vehicle body, the charging inlet port configured to electrically mate with and receive direct-current (DC) power from DC fast-charging (DCFC) cables of a donor vehicle and a charging station;
attaching a DC-to-DC (DC-DC) converter to the vehicle body; and
electrically connecting, via the DC-DC converter, the charging inlet port and the main HV bus such that the DC-DC converter is electrically interposed between the charging inlet port and the main HV bus, the DC-DC converter being operable in a bypass mode, in which the DC-DC converter passes therethrough the DC power received from the DCFC cable of the charging station, and a vehicle-to-vehicle (V2V) mode, in which the DC-DC converter regulates DC power received through the DCFC cable from the donor vehicle.

15. The method of claim 14, wherein the DC-DC converter includes a bypass switch switchable between a closed state, which places the DC-DC converter in the bypass mode, and an open state, which places the DC-DC converter in the V2V mode.

16. The method of claim 15, wherein the DC-DC converter further includes a first pair of electronic switches electrically connected in series with each other and arranged parallel to the bypass switch.

17. The method of claim 16, wherein the DC-DC converter further includes a capacitor electrically connected in parallel with the first pair of electronic switches and arranged parallel to the bypass switch.

18. The method of claim 14, further comprising:
attaching a battery disconnect unit (BDU) to the vehicle body; and
electrically connecting the BDU to the DC-DC converter and the rechargeable battery assembly, the BDU containing first and second relay switches switchable between closed and open states to selectively disconnect the DC-DC converter from the rechargeable battery assembly.

19. The method of claim 14, further comprising:
attaching a megawatt charging system (MCS) charging inlet port to the vehicle body; and
electrically connecting the MCS charging inlet port to the main HV bus, the MCS charging inlet port being configured to electrically mate with and receive electrical power from an MCS connector.

20. The method of claim 14, further comprising:
attaching an onboard charging module (OBCM) to the vehicle body; and
electrically connecting the OBCM to the charging inlet port, the OBCM being configured to regulate receipt of the DC power from the DCFC cables.
